(19) United States
(12) Patent Application Publication
(10) Pub. No.: US 2014/0326194 A1
(43) Pub. Date: Nov. 6, 2014

(54) Hamster Ball Containment Device

(71) Applicants: Beau Waswo, Dix Hills, NY (US); Julia Waswo, Dix Hills, NY (US)

(72) Inventors: Beau Waswo, Dix Hills, NY (US); Julia Waswo, Dix Hills, NY (US)

(73) Assignees: Julia Waswo, Dix Hills, NY (US); Beau Waswo, Huntington, NY (US)

(21) Appl. No.: 13/886,940

(22) Filed: May 3, 2013

(51) Int. Cl. A01K 15/02

(52) U.S. Cl. CPC A01K 15/025
USPC 119/707

(57) ABSTRACT

The Hamster Ball Containment Device provides a means to protect both the pets which use “hamster balls” to move about, and the people whom are in their presence, while also protecting the floor from animal droppings. The device is meant to be used in conjunction with a third party's “hamster ball”. The device is constructed of hollow foam tubes, connected together by smaller, rigid tubes which are inserted into the foam tube ends. The foam tubes are large enough in diameter to stop a traveling hamster ball, thus keeping the pet within the defined area. Attached to and beneath the assembled tubes lies a washable cloth; when the animal defecates, the cloth bottom shall protect the floor from damage.

### CROSS-REFERENCE TO RELATED APPLICATIONS

This patent application is related to, and claims priority from U.S. Provisional Patent Application No. 61/741,245 filed Jul. 16, 2012 entitled “Hamster Ball Containment Device”, by Beau Waswo.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### FIELD OF THE INVENTION

This invention relates generally to pet exercise toys and more particularly to pet containment devices which utilize exercise toys, such as the popular clear “hamster ball”. It can be classified as Animal Husbandry, and more specifically, a device in which the animal is forced to travel relative to an underlying, stationary surface.

### BACKGROUND OF INVENTION

Many small household pets are afforded travel and exercise by means of a “hamster ball”; however, these devices are inherently dangerous, given the environment of a household. The popular “hamster ball” is a clear plastic ball in which a hamster, mouse, gerbil, rat, or other small pet may be locked within and allowed to move about the yard or home. These hamster balls have no boundaries; as a result, an unsuspecting pet may find itself falling down a flight of stairs or tripping an unaware child or adult. This creates a risk of injury for both the animal and the person. Furthermore, as the pet is allowed to travel throughout a house or room, the opportunity for the animal to urinate or defecate throughout the home exists; thus creating a health hazard to the people in the home. Currently there is no product or device which explicitly accomplishes these goals.

### DISCUSSION OF RELATED PRIOR ART

As mentioned before, there is currently no product or device which performs the specific functions stated herein. However, there is related prior art, which while not accomplishing the same goal as the said invention, may be relevant to the Hamster Ball Containment Device: U.S. Pat. No. 5,477,814, Dated December, 1995, entitled “Track System With Exercise Ball”. This track system allows for an animal in a Hamster Ball to travel in a single direction along a predetermined track. It does not allow for the freedom of movement in all directions. It does not cite use for the prevention of contamination by animal excrement nor is it capable of such. It is a device created for the exercise of the animal and serves as entertainment for people.

### SUMMARY OF THE INVENTION

The Hamster Ball Containment Device provides a device for the retaining of small pets which utilize “hamster balls” as a means of movement while outside of their cages. The Hamster Ball Containment Device is meant to be used on the floor or ground; the device is used to create a containment area that does not allow the pet to leave the safety of the defined area. The Hamster Ball Containment Device allows for control of the area in which animal defecation occurs. It also ensures that the pet is in a known location at all times, while allowing the animal to exercise. It functions in such a way as to produce a physical barrier which is sufficiently high enough to block a hamster ball from being able to move over it.

### BRIEF DESCRIPTION OF THE DRAWINGS

FIG. 1 shows a top view of the assembled Hamster Ball Containment Device in accordance with a preferred embodiment of the present invention.

FIG. 2 is an assembly view from the top view perspective, showing the manner in which the individual components of the Hamster Ball Containment Device align to each other prior to assembly of the present invention.

FIG. 3 is a detailed view of the assembled device; particularly illustrating the way in which all the individual components, as well as the pet exercise ball interact with each other, according to the present invention.

FIG. 3A shows a detailed view, revealing hidden surfaces of the connections made between the tubular components as well as the hook and loop fastener.

FIG. 3B is a cutaway view of the assembled device, illustrating the spatial and size relationships between a generic hamster ball and the components of the present invention.

While the invention will be described in connection with a preferred embodiment, it will be understood that it is not the intent to limit the invention to that embodiment. It is the intent to cover all alternatives, modifications, and equivalents as may be included within the spirit and scope of the invention as defined by the appended claims.

### DETAILED DESCRIPTION OF A PREFERRED EMBODIMENT

Referring to the drawings generally, it is noted that like reference numerals are used to denote like components. The present invention is directed towards a modular device intended to control the area in which a small pet may move about while in its plastic exercise ball 5; and a removable floor covering 3 for protecting the home's floor from animal defecation.

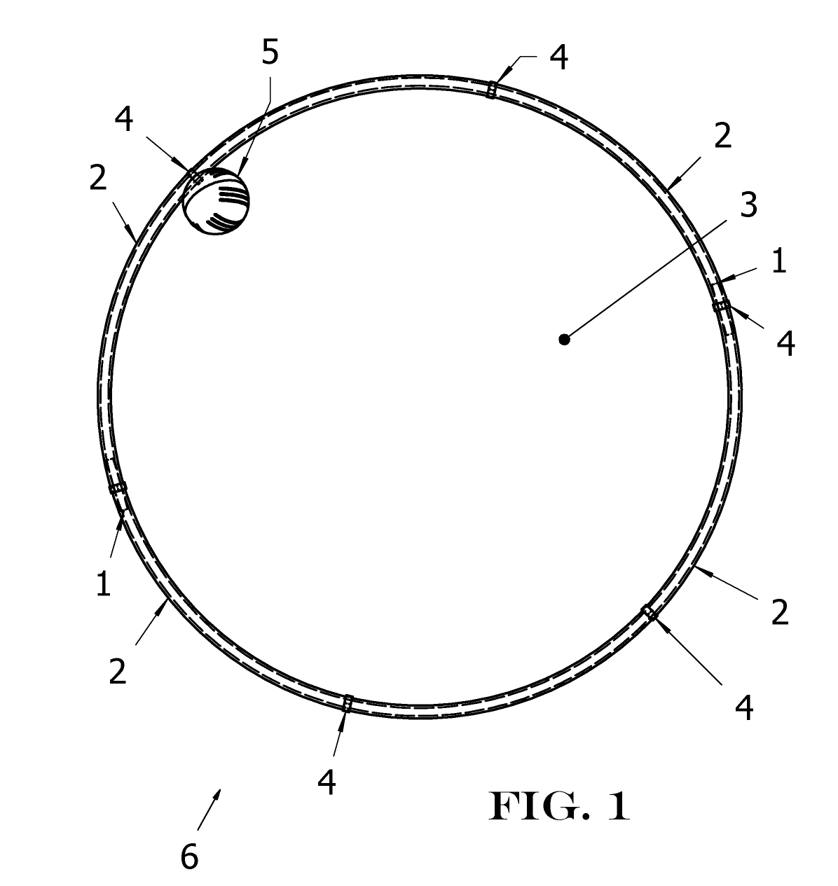

FIG. 1 depicts a typical Hamster Ball Containment Device 6, in assembled state, being composed of two tubular lengths of foam 2, having a rigid tubular insert 1 at each union of the larger foam tubes 2. The abovementioned tubular insert 1 is defined by having a slightly larger outside diameter than the inside diameter as well as a much smaller length, than that of the longer hollow foam pieces 2. The said tubular insert component is used for holding the larger foam segments together. Beneath the tubular sub-assembly, lies the floor covering 3 comprised of a washable material with six affixed tabs made from double-sided hook-and-loop fastener 4.

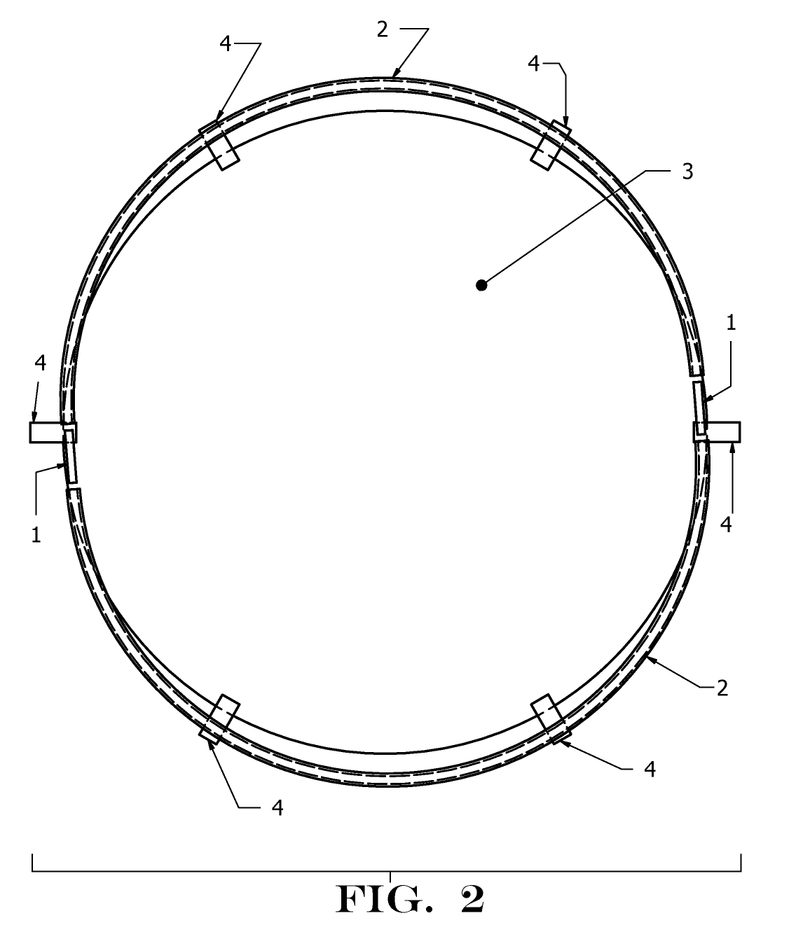

FIG. 2 depicts the device 6 as its separate components, in preparation for assembly. As shown, the larger tubular foam pieces 2 are bent in such a way as to create a circle. Said tubular foam sections 2 are to be connected axially at the hollow ends of each tube by means of insertion of a rigid tubular insert 1 at each junction. FIG. 2 shows that in addition to the structural components described above, there is a removable floor covering piece 3. For said floor covering 3, material is produced as to create a circular floor covering, equal in area to the area defined by the foam tubular structure of the Hamster Ball Containment Device 6. Said floor covering 3 possesses flaps around the edge which wrap around the above-mentioned foam tubing sections 2; securing the structural foam tubing 2 to the floor covering material 3. This floor covering is to be used to maintain the area in which the animal is defecating.

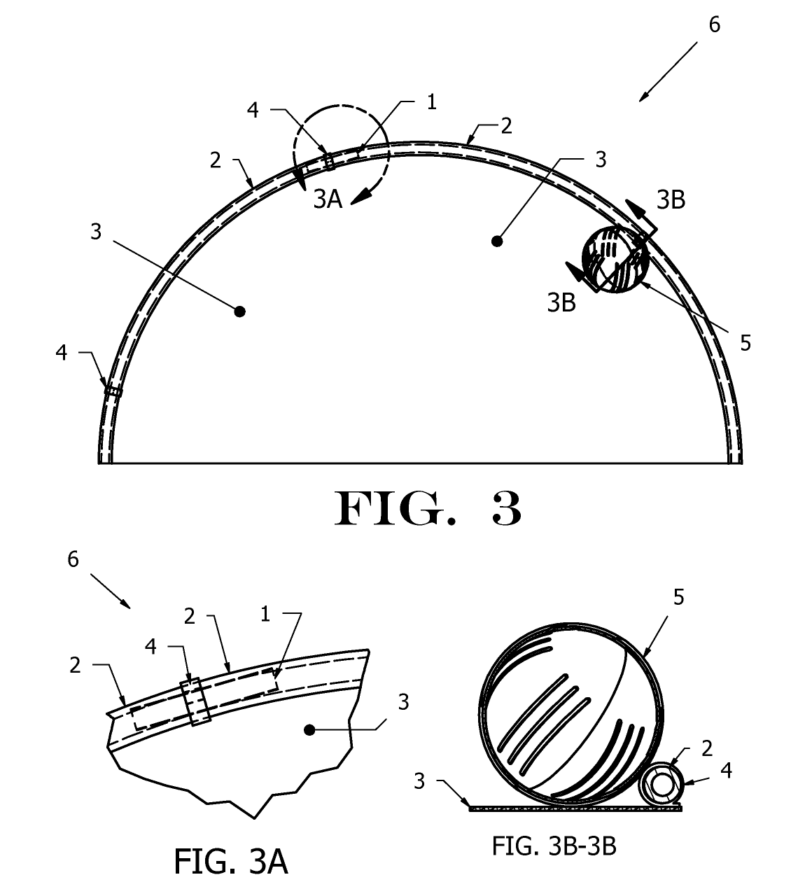

FIG. 3 shows a detailed view of the assembled Hamster Ball Containment Device 6, more specifically, FIG. 3A: the union at which the rigid tubular insert 1 is holding the flexible foam sections 2 together. It is seen that as the flexible foam length 2 is bent so as to produce a circle, the rigid tubular inserts are centered between the open ends of the foam lengths 2 and inserted equidistant into each open-ended, flexible foam piece 2. The tendency for the hollow foam cylinder 2 to return to its original condition of straightness creates a tension in the circle, wherein the said rigid tubular insert 1 holds the flexible sections together.

FIG. 3B displays a cutaway view, in which the relationship between the size of the hamster ball 5 and that of the containment device's wall height can be observed. It is clearly seen here, that length of the hook and loop fastener 4 is greater than the circumference of the flexible foam tubes 2, thus allowing the fastener 4 to completely wrap around the foam tube 2 and hook back on itself in a location between the floor covering 3 and the flexible foam tube 2. It is also apparent as to how the interaction between the hamster ball 5 and the said device 6 occurs. Although no specific dimension is necessary to classify, prototype trials indicate that 1.25″ outside diameter flexible foam tubing is sufficiently high enough to stop a traveling hamster ball.

All together, these components form the fully assembled version of the Hamster Ball Containment Device 6 as shown in this embodiment.

From the foregoing description, it will be apparent that modifications can be made to the apparatus and method for using same without departing from the teachings of the present invention. Accordingly, the scope of the invention is only to be limited as necessitated by the accompanying claims.

I claim:

1. Pet exercise ball containment device comprising:
a flexible tubular barrier restricting the area in which said ball may move about;
a rigid connecting tube, used to hold larger said flexible tube sections together by means of insertion;
a washable floor covering made of a flexible, lightweight fabric;
a set of hook-and-loop fasteners affixed to said floor covering which hold the said flexible tubular sections to said floor covering.

2. The exercise ball containment apparatus of claim 1 wherein said flexible tubular barrier is large enough in diameter as to inhibit said pet exercise ball's ability to overcome said tubular section's height while in movement.

3. The exercise ball containment apparatus of claim 1 wherein said rigid connecting tube is characterized by an outside diameter which is greater than the inside diameter of the larger said flexible tube,

4. The exercise ball containment apparatus of claim 1 wherein said flexible tubular section comprises a tubular length of extruded polyethylene or similar flexible foam.

5. The exercise ball containment apparatus of claim 1 wherein said floor covering is attached to said flexible tubular sections by means of said hook-and-loop fastener; said hook-and-loop fastener length exceeding the circumference of said flexible tube section, said hook-and-loop fastener being wrapped around tubular section laterally, and connected to said floor covering.

6. The exercise ball containment apparatus of claim 3 having said flexible floor covering as means to contain animal excrement, said floor covering comprising of a flexible fabric equal in area to that of the area created within comprised said flexible tubular sections.

7. The exercise ball containment apparatus of claim 4 having said flexible floor covering as means to contain animal excrement, said floor covering is removable for washing and storage by means of said hook-and-loop fastener.
